(19) United States
(12) Patent Application Publication
(10) Pub. No.: US 2012/0280414 A1
(43) Pub. Date: Nov. 8, 2012

(54) In-Process Monitoring for Composite Parts Quality Control Using Piezoelectric Wafer Active Sensors (PWAS) Technologies

(75) Inventors: Victor Giurgiutiu, Columbia, SC (US); Jingjing Bao, West Columbia, SC (US); Bin Lin, West Columbia, SC (US)

(73) Assignee: UNIVERSITY OF SOUTH CAROLINA, Columbia, SC (US)

(21) Appl. No.: 13/464,409

(22) Filed: May 4, 2012

Related U.S. Application Data
(60) Provisional application No. 61/518,364, filed on May 4, 2011.

(51) Int. Cl. B29C 45/76

(52) U.S. Cl. 264/40.1

(57) ABSTRACT

Methods of forming a molded composite material are generally provided. A composite forming precursor (e.g., fibers and/or a resin material) can be applied onto a mold that includes a plurality of piezoelectric sensors embedded into the mold. The composite forming precursor can then be cured adjacent to the mold to form a molded composite material. During curing, the molded composite material can be monitored, using the piezoelectric sensors to detect any defects formed during curing.

### PRIORITY INFORMATION

The present application claims priority to U.S. Provisional Patent Application Ser. No. 61/518,364 of Giurgiutiu, et al. titled “In-process monitoring for composite parts quality control using Piezoelectric Wafer Active Sensors (PWAS) technologies” filed on May 4, 2011, the disclosure of which is incorporated by reference herein.

### BACKGROUND

Structural health monitoring (SHM) is a method of determining the health of a structure from the readings of an array of permanently-attached sensors that are embedded into the structure and monitored over time. SHM can be performed in basically two ways, passive and active. Passive SHM consists of monitoring a number of parameters (loading stress, environment action, performance indicators, acoustic emission from cracks, etc.) and inferring the state of structural health from a structural model. In contrast, active SHM performs proactive interrogation of the structure, detects damage, and determines the state of structural health from the evaluation of damage extend and intensity. Both approaches aim at performing a diagnosis of the structural safety and health, to be followed by a prognosis of the remaining life. One widely used active SHM method employs piezoelectric wafer active sensors (see U.S. Pat. No. 7,024,315 of Giurgiutiu, which is incorporated by reference herein), which send and receive Lamb waves and determine the presence of cracks, delaminations, disbonds, and corrosion. The concept of a structural health monitoring system utilizing guided lamb waves embedded ultrasonic structural radar is proposed by Giurgiutiu et. al. in U.S. Pat. No. 6,996,480, which is incorporated by reference herein. Due to its similarities to NDE ultrasonics, this approach is also known as embedded ultrasonics.

Composite materials are combination of two or more materials on a macroscopic scale that may possess properties derived from its constituents or distinctly different. A common composite formulation consists of strong light fibers in a polymeric matrix. Composite material is an important class of engineering materials and structures that offer outstanding mechanical properties and unique design flexibility. Engineered composites must be formed to shape. This can be done by using prepregs or by resin transfer molding. A variety of molding methods can be used according to the end-item design requirements. The principal factors are the natures of the chosen matrix and reinforcement materials. Composite materials are used in a wide variety of applications including automotive parts, aviation, marine vessels, offshore structures, containers and piping, and sporting goods.

During the composites manufacturing process, it is important to check for degree of resin cure and detect various defects, such as air bubbles, dry patches, delaminations due to difference of coefficient of thermal expansion, pinholes, bridging, etc. Composites defects reduce composite structural strength and durability and can lead to costly rejects. A reject is even more costly if discovered only after the part was incorporated into a larger assemble. For these reasons, it is important to have an in-process monitoring system to ensure composite parts quality control while still in the mold.

Recently, a considerable amount of non-destructive evaluation methods has been used to inspect composites defects and cure process. For cure process, Shepard, et. al. measured the ultrasonic sound speed of thermosetting resins and composites as an in-process cure monitoring technique. Yenilmez, et. al., embedded dielectric sensors into the walls of a mold to monitor resin transfer molding to monitor resin transfer molding. Several NDE methods such as ultrasonic, radiography, thermography, laser shearography are used for defects detection. Computed Tomography (CT) radiographic technique is generally used for inspection of turbine blades. Thermal wave imaging for evaluation of aircraft skin corrosion and disbonding and laser shearography for disbond are used in traditional NDE. However, CT radiography, thermography and laser facilities are expensive; and the size of composite parts is limited.

As such, an affordable in-process nondestructive tool is desired to reliably detect, measure, and characterize the composite defects.

### SUMMARY

Objects and advantages of the invention will be set forth in part in the following description, or may be obvious from the description, or may be learned through practice of the invention.

In general, the present disclosure is directed toward, in one embodiment, methods of forming a molded composite material. A composite forming precursor (e.g., fibers and/or a resin material) can be applied onto a mold that includes a plurality of piezoelectric sensors embedded into the mold. The composite forming precursor can then be cured adjacent to the mold to form a molded composite material. During curing, the molded composite material can be monitored, using the piezoelectric sensors to detect any defects formed during curing.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows an in-progress monitoring composite mold with embedded PWAS according to one embodiment of the present invention.

### DETAILED DESCRIPTION OF INVENTION

The following description and other modifications and variations to the present invention may be practiced by those of ordinary skill in the art, without departing from the spirit and scope of the present invention. In addition, it should be understood that aspects of the various embodiments may be interchanged either in whole or in part. Furthermore, those of ordinary skill in the art will appreciate that the following description is by way of example only, and is not intended to limit the invention.

In general, methods and apparatus are provided for monitoring the structural health of a composite material as it is molded into a desired shape. In one embodiment, the methods and apparatus are particularly suitable for monitoring the structural health of the composite material as it is being molded simultaneously during curing of a precursor material into the composite material. Thus, methods and apparatus are described that can provide a non-intrusive in-situ evaluation method to improve the quality control of composite manufacturing processes.

Such in-process monitoring of composite material can be achieved utilizing piezoelectric wafer active sensors (PWAS) embedded into the mold during composite manufacturing. These methods and apparatus offer a revolutionary new approach to inspect composite parts quality during the manufacturing processes.

In one embodiment, an adhesive-free, couplant-free, self-monitoring composite mold embedded PWAS transducers is used to form the composite material. As such, the PWAS are positioned inside the mold's surface in a manner such that the PWAS can detect and quantify defects in the composite material as it is being formed in the mold. Accordingly, the PWAS embedded molds are reusable during the manufacturing process of many molded composite materials. The composite molds with embedded PWAS for detecting and quantifying defects can lead to significant improvements in the quality control of composite parts during manufacturing process and reduce costly rejects.

Multiple PWAS methods (pitch-catch, pulse-echo, phased-array, thickness mode, electromechanical impedance, etc.) can be used to detect manufacturing defects such as air bubbles, delamination, dry spots, pinhole, bridging, degree of resin cure, etc. These defects may reduce composite structural strength and durability. Their detection and characterization is important to industrial manufacturers. The composite thickness can be also in-situ monitored through the manufacture process with PWAS transducers.

In one embodiment, adhesive-free, couplant-free, self-monitoring composite molds are used with embedded PWAS transducers to improve the quality control during manufacturing processes. Instead of attaching PWAS permanently to the composite part, the PWAS is positioned inside the molds surface in a position such that the PWAS can monitor the structural health of the composite material as it is molded and/or cured.

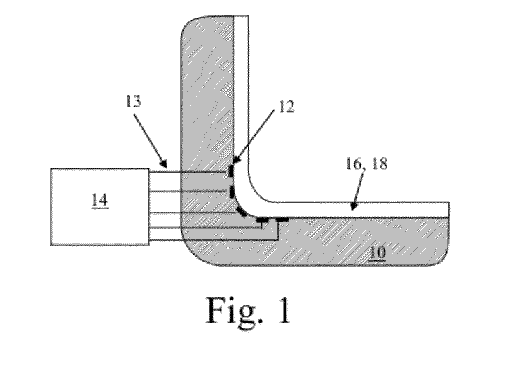

FIG. 1 shows one exemplary embodiment of such a mold 10 having embedded piezoelectric sensors 12 (e.g., PWAS) connected to an electronic module (e.g., for signal transmission/reception, processing, and/or interpretation) analyzer 14, such as a signal driver and/or analyzer). One or more communication links 13 (e.g., a wired or wireless communication link) allows the sensors 12 and the electronic module 14 to send and/or receive signals therebetween. In use, the composite forming precursor 16 is applied adjacent to the mold 10 and cured in working proximity to the sensors 12 to allow for monitoring, with the embedded piezoelectric sensors 12, the molded composite material 18 during curing of the precursor 16 to detect any defects formed.

In one particular embodiment, the piezoelectric sensors 12 can be piezoelectric wafer active sensors (PWAS). Just like conventional ultrasonic transducers, PWAS utilize the piezoelectric effect to generate and receive ultrasonic waves. However, PWAS are different from conventional ultrasonic transducers in several aspects. First, PWAS are typically firmly coupled with the structure through a bonding, whereas conventional ultrasonic transducers are weakly coupled through gel, water, or air. Second, PWAS are non-resonant devices that can be tuned selectively into several guided-wave modes, whereas conventional ultrasonic transducers are resonant narrow-band devices. Finally, PWAS are inexpensive and can be deployed in large quantities on the structure, whereas conventional ultrasonic transducers are expensive and used one at a time. Thus, PWAS transducers can serve several purposes, including high-bandwidth strain sensors; high-bandwidth wave exciters and receivers; resonators; and/or embedded modal sensors with the electromechanical (E/M) impedance method.

By application types, PWAS transducers can be used for a variety of applications, including, for example, active sensing of far-field damage using pulse-echo, pitch-catch, and phased-array methods; active sensing of near-field damage using high-frequency E/M impedance method and thickness-gage mode; and/or passive sensing of damage-generating events through detection of low-velocity impacts and acoustic emission at the tip of advancing cracks.

According to the presently disclosed methods, bonding is achieved between sensors 12 and the material during the vacuum bag/pressure molding process. For example, the composite forming precursor (e.g., fibers and/or resins) are sufficiently and removeably attached to the mold, and herein generate a good structural coupling between the composite material 16, 18 and sensors 12. Before the composite material 18 is taken out and removed from the mold 10, multiple PWAS methods mentioned above can be used to monitor the resin cure process and detect defects.

For example, the sensors can be utilized to determine the health of the composite structure as it is being molded. Suitable methods and equipment that can be utilized to determine the health of the composite structures using such sensors are described in U.S. Pat. No. 7,881,881 of Giurgiutiu, et al.; U.S. Pat. No. 8,102,101 of Giurgiutiu, et al.; and U.S. Publication No. 2009/0048789 of Yu, et al. all of which are incorporated by reference herein. However, as stated above, according to the presently described methods, the sensors are positioned within the mold adjacent to the composite material formed instead of embedded within or on the structure itself.

In one embodiment, the mold 10 can include a plurality of sensors 12 in an array. For example, the sensors 12 can be positioned within the mold 10 in a random arrangement, in a linear array, in a planar array, in a circular array (e.g., a plurality of concentric circles), etc. As shown, the sensors 12 can be positioned within a curvature or bend defined by the mold 12.

Additional electronics, such as a signal driver, signal analyzer, etc., may be included within or in working proximity to the mold 12. The electronic module for signal transmission/reception, processing, and interpretation can be comprised of, in one embodiment: (a) a one-burst signal generator which creates a synthesized window-smoothed tone-burst signal with adjustable amplitude and repetition rate; (b) a transmission beamformer (algorithm); (c) a reception beamformer (algorithm); (d) a high-speed A/D converter and digital storage; and (e) a signal processing unit for signal enhancement, time of flight (TOF), and range estimation.

For example, in one particular embodiment, a generator can also be included in working proximity to the mold that is operative to impress a pulse having a predetermined carrier frequency upon at least one of the PWAS to produce guided ultrasonic waves that travel along the composite material as it is being molded and/or cured. Additionally, a signal processor can also be included in the mold that is operative to process received signals at the PWAS resulting from an echo from a disruption in the uniformity of the composite material (e.g., a non-uniformity, such as a crack). The processor can be implementing a synthetic beamforming methodology for determining an angular position of the non-uniform area spaced apart from the plurality of sensors along a plane of the mold, allowing the processor to calculate a distance to the non-uniform area.

Utilizing the unique properties of PWAS, the following methods can be applied in this invention to detect composite structure anomalies during manufacturing process:
1. Thickness mode and high frequency resonators for in-process resin cure monitoring. The acoustic speed in the composite part is measured throughout the process to determine the complete resin cure.
2. Thickness mode for delamination and bridging detection.
3. Electromechanical impedance spectroscopy (EMIS) for near-field defects
4. PWAS phased array, pitch-catch, pulsed-echo technologies for defects characterization.

In summary, methods and systems of monitoring for defects formed during composite manufacturing process is provided utilizing a PWAS embedded mold, particularly with molds with embedded PWAS transducers. Thus, methods are provided of using PWAS thickness mode and PWAS resonators for composite resin cure monitoring. The self-monitoring composite molds with embedded PWAS transducers can provide an inexpensive non-intrusive in-process monitoring method.

The methods described herein can provide an independent and long-term solution for in-process monitoring, a way to characterization composites defects using PWAS technologies, an inexpensive and multiply-use solution for composites monitoring, and/or a residues free (adhesive-free, couplant-free) NDE evaluation for composites manufacturing.

The major potential industrial application of these methods is in composite manufacture. With the inexpensive and durable self-monitoring composite molds with embedded PWAS transducers, the methods can provide a simple solution for monitoring composite parts during manufacturing process that is likely to be adopted by many industrial users, such as federal and industrial laboratories, original equipment manufactures, operators of large critical infrastructure projects (bridges and buildings), aerospace, energy generation, nuclear oil, automotive and related industrials that are required to assure the safety of their product by structure healthy monitoring and nondestructive evaluation.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of forming a molded composite material, the method comprising:
applying a composite forming precursor onto a mold, wherein the mold comprises a plurality of piezoelectric sensors embedded into the mold;
curing the composite forming precursor adjacent to the mold to form a molded composite material; and
monitoring, with the embedded piezoelectric sensors, the molded composite material during curing to detect any defects formed during curing.

2. The method of claim 1, wherein the piezoelectric sensors are piezoelectric wafer active sensors.

3. The method of claim 1, wherein the plurality of piezoelectric sensors are embedded in said mold in a random arrangement.

4. The method of claim 1, wherein the plurality of piezoelectric sensors are embedded in said mold in a planar array.

5. The method of claim 1, wherein the plurality of piezoelectric sensors are embedded in said mold in a circular array.

6. The method of claim 5, wherein the circular array corresponds to a plurality of concentric circles.

7. The method of claim 1, wherein the composite forming precursor comprises fibers in a polymeric matrix.

8. The method of claim 1, wherein curing is achieved via heating the composite forming precursor to a curing temperature.

9. The method of claim 8, wherein the curing temperature is about 100° C. to about 350° C.

10. The method of claim 8, wherein the composite forming precursor is cured at the curing temperature for about 1 hour or longer.

11. The method of claim 1, further comprising:
after curing, removing the molded composite material from the mold while leaving the plurality of piezoelectric sensors embedded within the mold.

12. The method of claim 11, further comprising:
applying a second composite forming precursor onto the mold;
curing the second composite forming precursor adjacent to the mold to form a second molded composite material; and
monitoring, with the embedded piezoelectric sensors, the second molded composite material during curing to detect any defects formed during curing.

13. The method of claim 12, wherein curing is achieved via heating the second composite forming precursor to a second curing temperature.

14. The method of claim 12, after curing, removing the second molded composite material from the mold while leaving the plurality of piezoelectric sensors embedded within the mold.

15. The method of claim 14, further comprising:
applying a third composite forming precursor onto the mold;
curing the third composite forming precursor adjacent to the mold to form a third molded composite material; and
monitoring, with the embedded piezoelectric sensors, the third molded composite material during curing to detect any defects formed during curing.

16. The method of claim 15, after curing, removing the third molded composite material from the mold while leaving the plurality of piezoelectric sensors embedded within the mold.

17. The method of claim 1, wherein the embedded piezoelectric sensors are in communication with an analyzer via a communication link.
